(19) United States
(12) Patent Application Publication
(10) Pub. No.: US 2004/0048165 A1
(43) Pub. Date: Mar. 11, 2004

(54) Electrolyte for a secondary cell

(76) Inventor: Fazlil Coowar, Sugarland, TX (US)

Correspondence Address: William H Holt, Law offices of William H Holt, Unit 2 First Floor, 1423 Powhatan street, Alexandria, VA, 22314, US

(21) Appl. No.: 10/381,878

(22) PCT Filed: Sep. 20, 2001
(86) PCT No.: PCT/GB01/04183

(30) Foreign Application Priority Data
Oct. 5, 2000 (GB) 0024347.7

(51) Int. Cl. H01M 10/40; H01M 4/58

(52) U.S. Cl. 429/332; 429/231.8

(57) ABSTRACT

A reversible lithium ion cell has a graphitic material as the anode material, and the electrolyte includes propylene carbonate and also a chlorinated diethyl carbonate, and a lithium salt, the concentration by weight of the chlorinated diethyl carbonate being less than 2%. The chlorinated diethyl carbonate appears to form a passivating layer on the surface of the graphite that prevents interaction of propylene carbonate with graphite, but does not impede reversible intercalation of lithium ions. Such cells may be used over a wide temperature range, and have good capacity.

This invention relates to a secondary lithium ion cell, and to an electrolyte composition for such a cell.

For many years it has been known to make cells with lithium metal anodes, and cathodes of a material into which lithium ions can be intercalated or inserted. A wide variety of intercalation or insertion materials are known as cathode materials for rechargeable lithium cells, such as TiS₂, V₆O₁₃ and LiₓCoO₂ where x is less than 1; and these materials are often mixed with solid electrolyte material to form a composite cathode. To avoid the problems arising from dendrite growth at lithium metal anodes during cycling, it has been proposed to use an intercalation material such as carbon as the anode material, and this also may be mixed with solid electrolyte material to form a composite anode. Rechargeable cells of this type, in which both the anode and cathode contain intercalated lithium ions, are now available commercially, and may be referred to as lithium ion cells, or as swing or rocking-chair cells.

Several different carbonaceous materials such as coke, graphite or carbon fibre have been suggested for use in anodes. Graphitic materials are desirable, as they can intercalate lithium ions readily and reversibly, but they have been found to be unsuitable for cells with certain electrolytes, in particular those containing propylene carbonate. Such cells suffer a large irreversible loss of capacity on the first cycle. It has been suggested that this may be due to the intercalation of propylene carbonate along with lithium ions into the graphite structure, followed by reaction of the propylene carbonate to form propylene gas. Nevertheless propylene carbonate would have benefits as a component of an electrolyte, in particular because it is liquid over a wide temperature range, −55° C. to 240° C., and because of its high boiling point it has a low vapour pressure. It has also been suggested, in U.S. Pat. No. 5,910,381 (Barker et al.), that this problem can be overcome by including a chlorinated diethyl carbonate in the electrolyte at a concentration between 2% and 75% by weight, although this compound is apparently not stable in the presence of LiPF₆. Surprisingly, it has now been found that even better results can be obtained using concentrations less than 2%, and at such concentrations there are no problems in use of the salt LiPF₆.

Thus the present invention provides an electrolyte for a reversible lithium ion cell, the electrolyte including propylene carbonate, and also including a chlorinated diethyl carbonate, and a lithium salt, the concentration by weight of the chlorinated diethyl carbonate being less than 2%.

Preferably the concentration of the chlorinated diethyl carbonate is between 1 and 2%, more preferably between 1.5 and 2.0%, for example 1.8% by weight. The preferred chlorinated diethyl carbonate is chloroethyl-ethyl-carbonate.

The carbonaceous material can be characterized by its “degree of graphitization”, g, which typically will lie between 0 and 1 although it may lie outside this range. Carbon with a high degree of graphitization, say above 0.7, has a microstructure that resembles the layered microstructure of graphite, whereas carbon having a lower degree of graphitization has a less ordered microstructure approaching that of coke. Graphitic carbon, which has a high degree of graphitization, provides a good charge capacity as it can form LiₓC₆ with x approaching 1, and also provides voltage stability during operation. The degree of graphitization, g, can be determined by measuring the interlayer distance spacing of the (002) planes, d, using X-ray diffraction (this distance being typically about 0.335 nm or 0.336 nm for graphite), and:

g=(0.345−d)/0.0085

where d is in nm.

Thus the invention also provides a reversible lithium cell in which the anode comprises carbonaceous material, the electrolyte including propylene carbonate, and also including a chlorinated diethyl carbonate, and a lithium salt, the concentration by weight of the chlorinated diethyl carbonate being less than 2%.

Preferably the carbonaceous material has a degree of graphitization of at least 0.4 and more preferably at least 0.8. The carbonaceous material may alternatively be characterized as one with which propylene carbonate would irreversibly react during charging, if the chlorinated diethyl carbonate were not present. For example the carbonaceous material may comprise mesocarbon microspheres heat treated at between 2500° C. and 2900° C. for which, as described in U.S. Pat. No. 5,344,724 (Ozaki et al.), the value of d is in the range 0.336 to 0.339 nm.

A lithium ion cell consists of an anode layer in contact with an anode current collector, a cathode layer in contact with a cathode current collector, and a layer of electrolyte between the anode layer and the cathode layer. The anode layer of the present invention comprises graphitic carbon in particulate form, held together by a binder. The cathode layer comprises a suitable insertion material such as LiₓCoO₂ or spinel LiMn₂O₄ in particulate form held together by a binder. The cathode layer will typically also include an electrically conductive material such as carbon black. These layers may be made by casting a mixture of the particulate material and the binder in solution in a volatile solvent, and evaporating the solvent. If the electrolyte is a liquid then, to ensure separation, a separator is generally provided between the anode layer and the cathode layer. The separator may be a porous inert sheet for example of glass fibre, polypropylene, or polyethylene. More preferably the separator is a polymeric sheet that form a gel-like layer when impregnated by a non-aqueous solvent that acts as a plasticiser; desirably the sheet is microporous. A suitable polymeric sheet comprises a polymer such as polyvinylidene fluoride (PVdF), or a copolymer of vinylidene fluoride with hexafluoropropylene (PVdF/HFP), and these polymeric materials are also suitable as binders for the anode layer and the cathode layer.

The invention will now be further and more particularly described, by way of example only, and with reference to the accompanying drawings in which:

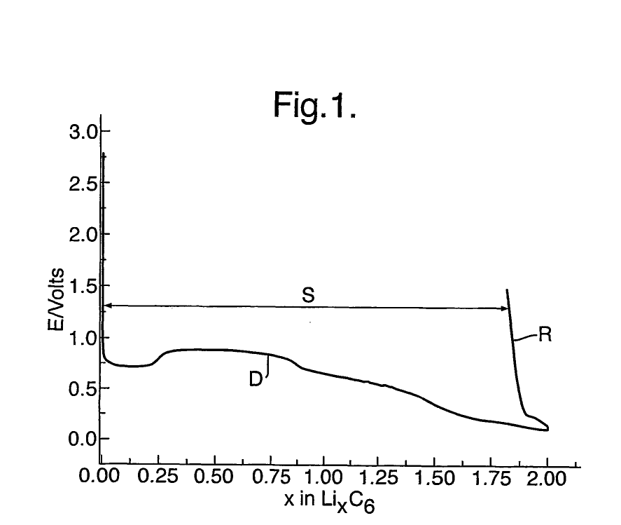

FIG. 1 shows graphically the variation of voltage with capacity during the first cycle for a half-cell in which the electrolyte contains no chlorinated diethyl carbonate; and

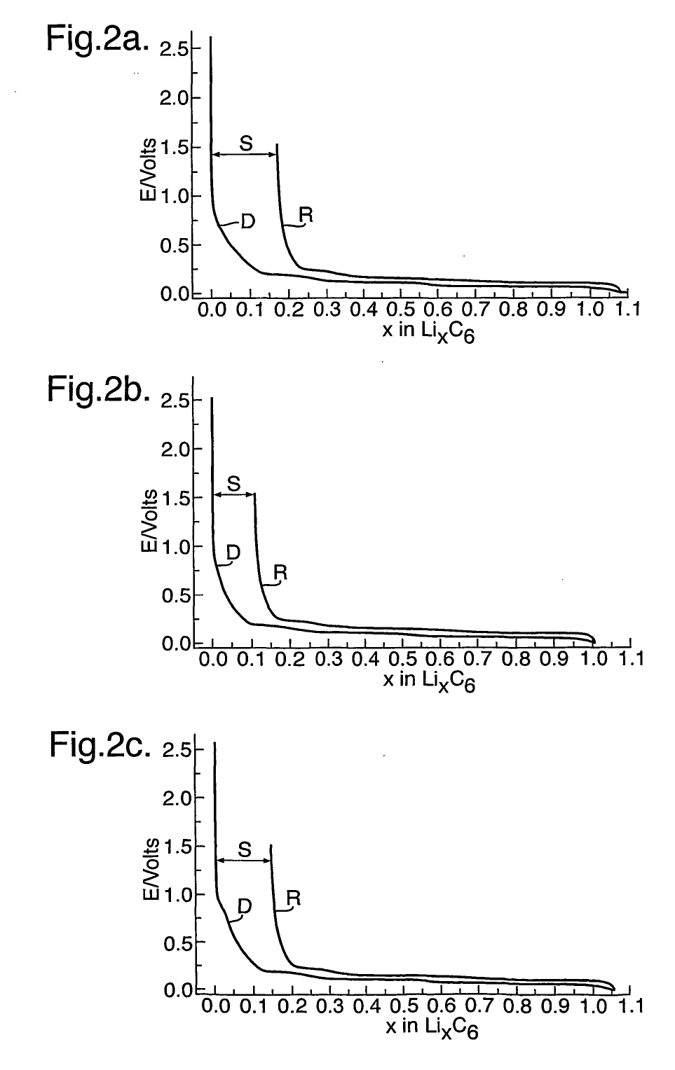

FIGS. 2a-c shows graphically the variation of voltage with capacity during the first cycle for half-cells in which the electrolyte contains small quantities of chlorinated diethyl carbonate.

By way of example, secondary lithium ion cells can be made by a procedure as follows.

Making the Electrodes

A cathode is made by making a mixture of lithium cobalt oxide LiₓCoO₂, a small proportion of conductive carbon, and homopolymer PVdF 1015 as binder, this being cast from solution in N-methyl-pyrrolidone (NMP) which is a solvent for the PVdF. This grade of PVdF homopolymer, from Solvay, is characterized by having a low value of melt flow index, about 0.7 g/10 min at 10 kg and 230° C., this parameter being measured by the method in standard ASTM D 1238. The mixture is cast, using a doctor blade, onto an aluminium foil, being passed through a dryer with temperature zones at for example 80° C. and 120° C., to ensure evaporation of all the NMP (of which the boiling point is about 203° C.). This process may be repeated to produce a double-sided cathode. Removal of the NMP may be further ensured by subsequent vacuum drying.

An anode is made by making a mixture of mesocarbon microbeads of particle size 10 μm, heat treated at 2800° C. (MCMB 1028), with a small amount of graphite, and homopolymer PVdF 1015 as binder. This mixture is cast from solution in NMP, onto a copper foil, in a similar fashion to that described in relation to the cathode.

Making the Porous Membrane

Homopolymer PVdF grade 1015 is dissolved in dimethyl formamide (DMF) at 45° C. A small quantity, less than 10% by weight, of 1-octanol is then added dropwise and carefully mixed to ensure homogeneity. The resulting mixture is then cast, using a doctor blade, onto an aluminium foil substrate to form a layer initially 0.25 mm thick, and then passed through a dryer with successive drying zones at 65° C. and 100° C. Within the drying zones it is exposed to dry air flow to remove the solvent (DMF) and non-solvent (1-octanol) as they evaporate, this dry air being obtained by passing air through a dehumidifier such that the dewpoint is minus 40° C.

This produces a white polymer membrane, of thickness about 20-25 μm, and which is microporous, with pores in the size range 0.5-2.0 μm. This membrane is peeled off the substrate, and subsequently dried in a vacuum to ensure removal of all traces of both solvent and non-solvent.

Cell Assembly

Several cells are then assembled with the microporous membrane separating the anode from the cathode, for example prismatic wound flat cells. These assemblies may then be vacuum dried at say 60° C. for several hours to ensure removal of all solvents and any traces of water. An electrolyte solution containing one or more lithium salts dissolved in an organic solvent that acts as a plasticiser, which in this example may comprise propylene carbonate, ethylene carbonate and say 1.8% by weight of chloroethyl-ethyl-carbonate, is then injected into the dried cells, and the cells are left to soak at ambient temperature for several hours so all the components are thoroughly impregnated by the solution. Each cell is then vacuum-packed and sealed, for example in a flexible laminated aluminium foil pack.

Experimental Tests on Electrolytes

The performance of different non-aqueous electrolytes has been experimentally investigated using half-cells, one electrode being of mesocarbon microbeads heat treated at 2800° C. (MCMB 1028), and the other electrode being of lithium metal. Referring to the figures, these show the variation of voltage with the amount of charge that has passed (which is assumed to be equivalent to the amount of intercalated lithium, i.e. the value of x in LiₓC₆) during the first cycle. In each case the current density was 0.164 mA/cm²; the discharge was terminated when the cell voltage dropped to 0.005 V, and the recharge was terminated when the cell voltage rose to 1.5 V. The graph of voltage variation during discharge is marked D, and that during recharge is marked R in each case. Ideally the discharge and recharge graphs would be identical; the spacing S between the vertical parts of the two graphs is indicative of the irreversible loss of capacity during this first cycle.

FIG. 1 is for a half-cell in which the electrolyte consists of a 1 molar solution of LiPF₆ in a mixture of 3 parts ethylene carbonate and 2 parts propylene carbonate (by weight). In this case the cell voltage is high and variable during discharge, and there is a very large and irreversible loss of capacity. This is presumably due to electrodecomposition of propylene carbonate, or other side-reactions, so that the amount of lithium that is actually intercalated is presumably much less than the values of x given.

FIG. 2 shows results for half-cells in which the electrolytes consist of a 1 molar solution of LiPF₆ in a mixture of 3 parts ethylene carbonate and 2 parts propylene carbonate (by weight), to which is added a small proportion of chloroethyl-ethyl-carbonate: in FIG. 2a the amount is 1.0% by weight, in FIG. 2b it is 1.78% by weight, and in FIG. 2c it is 5% by weight. (These electrolytes may be referred to as “electrolyte+1”, “electrolyte+1.78”, etc.) It is clear from these graphs that the provision of this chlorinated diethyl carbonate has a beneficial effect on cell performance, both in reducing the voltage of the carbon electrode relative to lithium, and in considerably reducing the irreversible loss of capacity, S. It is also apparent that the capacity loss, S, is least in the graph of FIG. 2b, that is to say with 1.78% of chloroethyl-ethyl-carbonate. Similar measurements have also been made with 10% of chloroethyl-ethyl-carbonate, and the irreversible capacity loss on the first cycle is even higher.

The values of the discharge capacity, Qd (expressed in mA h/g), and the corresponding recharge capacity, Qr, for the first cycle, and hence the Coulombic efficiency, E, are shown in the following table.

TABLE

| | Qd/mA h g⁻¹ | Qr/mA h g⁻¹ | E/% |
|---|---|---|---|
| Electrolyte + 1 | 401.74 | 338.55 | 84.27 |
| Electrolyte + 1.78 | 373.93 | 333.55 | 89.2 |
| Electrolyte + 5 | 393.17 | 338.8 | 86.17 |
| Electrolyte + 10 | 401.38 | 332.53 | 82.84 |

The theoretical discharge capacity, assuming the formation of LiC₆, would be 372 mA h/g, and the values of Qd that are greater than this are indicative of side reactions. Such side reactions can be expected to bring about a thicker passivated layer at the surface of the graphite, and so lead to greater internal resistance of the cell. Furthermore such side reactions may consume lithium ions, so reducing the amount of lithium available for subsequent cycles. It is evident that the peak efficiency is achieved with an electrolyte containing about 1.8% by weight of chloroethyl-ethyl-carbonate.

It will be appreciated that a cell may have an electrolyte differing from that described above while remaining within the scope of the invention. In particular, the proportion of propylene carbonate may be different. For example propylene carbonate might be the only plasticising electrolyte solvent (apart from the chloroethyl-ethyl-carbonate); alternatively propylene carbonate might be only 10% of the electrolyte solvent. The electrolyte might contain a lithium salt other than that described above, for example LiBF₄, or a mixture of lithium salts. Furthermore the electrolyte solution that is added to the cells may contain other plasticising solvents, such as dimethyl carbonate, which are compatible with the electrode materials, and may also contain polymeric material, such as PVdF/HFP copolymer or polyvinyl acetate, in solution. If such polymeric material is provided, it is preferably between 75 and 25%, say 50%, of the electrolyte mixture, so that it will gel after it has been injected into the cell.

1. An electrolyte for a reversible lithium ion cell, the electrolyte including propylene carbonate, and also including a chlorinated diethyl carbonate, and a lithium salt, characterised by the concentration by weight of the chlorinated diethyl carbonate being less than 2%.

2. An electrolyte as claimed in claim 1 wherein the chlorinated diethyl carbonate is chloroethyl-ethyl-carbonate.

3. A reversible lithium ion cell in which the anode comprises carbonaceous material, the electrolyte including propylene carbonate, and also including a chlorinated diethyl carbonate, and a lithium salt, characterised by the concentration by weight of the chlorinated diethyl carbonate being less than 2%.

4. A cell as claimed in claim 3 in which the carbonaceous material has a degree of graphitization of at least 0.4 and more preferably at least 0.8.

5. A cell as claimed in claim 3 in which the carbonaceous material is one with which propylene carbonate would irreversibly react during charging, if the chlorinated diethyl carbonate were not present.

6. A cell as claimed in any one of claims 3 to 5 wherein the chlorinated diethyl carbonate is chloroethyl-ethyl-carbonate.
